(19) United States
(12) Patent Application Publication
(10) Pub. No.: US 2023/0377265 A1
(43) Pub. Date: Nov. 23, 2023

(54) Systems for Efficiently Rendering Vector Objects

(71) Applicant: Adobe Inc., San Jose, CA (US)

(72) Inventors: Harish Kumar, Noida (IN); Apurva Kumar, Patna (IN)

(73) Assignee: Adobe Inc., San Jose, CA (US)

(21) Appl. No.: 17/746,052

(22) Filed: May 17, 2022

(51) Int. Cl. G06T 17/20; G06T 15/00

(52) U.S. Cl. CPC G06T 17/20; G06T 15/005; G06T 2219/2016

(57) ABSTRACT

In implementations of systems for efficiently rendering vector objects, a computing device implements a rendering system to identify unique geometries from a set of geometries of vector objects included in a render tree. The rendering system tessellates the unique geometries and each of the tessellated unique geometries has a unique identifier. Mappings are generated between the vector objects included in the render tree and the tessellated unique geometries using the unique identifiers. The rendering system renders the vector objects included in the render tree for display in a user interface based on the mappings.

### BACKGROUND

Rendering vector graphics for display in a user interface of a display device having a resolution of 4K or greater is a computationally intensive process. Even with the support of graphics processing units (GPUs), there are still many scenarios in which hardware of a computing device is not capable of rendering the vector graphics in substantially real time as a user interacts with an input device (e.g., a mouse, a stylus, etc.) relative to the user interface. In these scenarios, the rendered vector graphics appear “choppy” as the user manipulates the vector graphics in the user interface via the input device.

Conventional rendering systems use batch rendering techniques to reduce GPU draw calls and use GPU cores in parallel. These techniques render vector objects having similar appearance attributes as if they were a single vector object. Although batch rendering uses the hardware of the computing device more efficiently in some scenarios, this improvement is insufficient to prevent rendered vector graphics from appearing “choppy” in many scenarios.

### SUMMARY

Techniques and systems for efficiently rendering vector objects are described. In one example, a computing device implements a rendering system to identify unique geometries from a set of geometries of vector objects included in a render tree. For instance, the rendering system identifies the unique geometries by matching geometries of pairs or groups of the vector objects.

The rendering system tessellates the unique geometries and the tessellated unique geometries each have a unique identifier. For example, mappings are generated between the vector objects included in the render tree and the tessellated unique geometries using the unique identifiers. The rendering system renders the vector objects for display in a user interface based on the mappings.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ digital systems and techniques for efficiently rendering vector objects as described herein.

FIG. 2 depicts a system in an example implementation showing operation of a rendering module for efficiently rendering vector objects.

FIGS. 3A, 3B, 3C, 3D, 3E, and 3F illustrate an example of efficiently rendering a vector object.

FIG. 4 is a flow diagram depicting a procedure in an example implementation in which unique geometries are identified from a set of geometries of vector objects included in a render tree and the vector objects are rendered for display in a user interface based on the unique geometries.

FIGS. 5A and 5B illustrate an example of efficiently rendering vector-based glyphs.

FIG. 6 illustrates an example system that includes an example computing device that is representative of one or more computing systems and/or devices for implementing the various techniques described herein.

### DETAILED DESCRIPTION

Overview

Even with use of GPUs and batch processing techniques, there are still many scenarios in which conventional rendering systems are not capable of rendering vector graphics in substantially real time such as when the vector graphics are displayed in a user interface of a display device having a resolution of 4K or greater. In these scenarios, the rendered vector graphics appear “choppy” as a user manipulates the vector graphics in the user interface via an input device (e.g., a mouse, a touchscreen, etc.). In order to overcome the limitations of conventional systems, techniques and systems for efficiently rendering vector objects are described.

In an example, a computing device implements a rendering system to identify unique geometries from a set of geometries of vector objects included in an input render tree. The vector objects are ordered in a z-order in the input render tree, and the vector objects are to be rendered as part of a rendering pipeline. For example, the rendering system identifies the unique geometries by matching geometries of pairs or groups of the vector objects.

In order to match geometries of the vector objects that are fills, the rendering system determines that all fills have matching geometries unless some vector effect (e.g., a visual feature) is applied over a particular fill. For matching geometries of the vector objects that are vector shapes, the rendering system matches a first geometry and a second geometry if the first and second geometries are affine transforms of each other. For example, if the first geometry matches the second geometry, then the first geometry is a rotated, translated, and/or scaled version of the second geometry or the second geometry is a rotated, translated, and/or scaled version of the first geometry.

To match geometries of the vector objects that are strokes, the rendering system first compares stroke attributes of a pair or group of stroke paths such as stroke width, dash patterns, types of caps and joins, and so forth. If the pair or group of stroke paths have matching stroke attributes, then the corresponding vector objects that are strokes have matching geometries if outlines of the pair or group of stroke paths are affine transforms of each other (e.g., an outline of one stroke path is a rotated, translated, and/or scaled version of an outline of another stroke path). However, a vector object that is a stroke does not have a matching geometry with a vector object that is a fill even if an outline of the stroke and an outline of the fill are exactly the same.

The rendering system identifies the unique geometries based on the pairs or groups of the vector objects having matching geometries and assigns a unique identifier (e.g., a unique integer identifier) to each of the unique geometries. For example, the rendering system tessellates each of the unique geometries into a set of triangles and generates vertex data for each of the tessellated unique geometries that describes coordinates of vertices of the triangles. In this example, the vertex data for each of the tessellated unique geometries also includes metadata describing a corresponding unique identifier that associates each vertex with one of the unique geometries. The rendering system aggregates the vertex data for each of the tessellated unique geometries into a single aggregated data buffer which is used as a vertex array buffer for all draw calls issued for the input render tree.

For instance, the rendering system computes an optimal render tree for rendering the vector objects included in the input render tree. The optimal render tree includes optimal render objects that each require one draw call on a GPU. Thus, the rendering system computes the optimal render tree to include a minimum number of the optimal render objects.

However, some visual appearance attributes such as blend modes interact with a backdrop color to compute a final output color on a render target. For these visual appearance attributes, a read is only performable correctly if a write was performed during a previous draw call using barriers and other synchronization primitives. Since the GPU does not support read-after-write memory consistency during a fragment shader stage of the rendering pipeline if read and write operations to a render target are performed in a single draw call, the rendering system adds a new optimal render object to the optimal render tree each time such an appearance attribute (e.g., a blend mode) is encountered in the input render tree.

In some examples, each optimal render object in the optimal render tree includes metadata describing all of the vector objects included in the input render tree that map to the optimal render object. By leveraging this metadata, the rendering system is capable of rendering more than one of the vector objects in a single draw call using instanced rendering. The rendering system computes a minimum number of instances for each of the optimal render objects such that each of the vector objects included in the input render tree that map to each of the optimal render objects are rendered. For example, the vector objects need to be ordered based on their z-order in the input render tree and the vertex array buffer is ordered based on occurrences of the unique geometries in the input render tree.

After computing the minimum number of the instances for each of the optimal render objects, the rendering system computes a primitive mask array for each of the instances. For example, the primitive mask arrays are defined such that if an ith bit of a primitive mask array is set to 1, then the corresponding instance needs to render a geometry correspond to unique geometry i. The rendering system executes a vertex shader for all vertices in the vertex array buffer and uses the primitive mask arrays for each of the instances to determine which vertices to pass to a next stage of the rendering pipeline. For instance, the rendering system leverages the vertex shader to filter out all vertices that do not correspond to a value of 1 in the primitive mask arrays.

The rendering system passes the remaining vertices to a fragment shader which computes final colors for each rasterized fragment based on appearance attributes for corresponding instances and outputs to a render target. For example, the rendering system combines the render targets to render the vector objects included in the input render tree. By only tessellating the unique geometries in this manner, the described systems render the vector objects with improved efficiency relative to conventional rendering systems that tessellate each geometry of the vector objects included in the input render tree in order to render the vector objects. This efficiency improvement is realized in any scenario in which a number of unique geometries of the vector objects is less than a total number of geometries of the vector objects in the input render tree and no decrease in efficiency is realized otherwise. Moreover, the described systems are implementable in any platform and are compatible with all GPU devices. Further, the described systems are capable of rendering vector graphics in substantially real time even when the rendered vector graphics are displayed in a user interface of a display device having a resolution of 4K or greater which is not possible using conventional rendering systems.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Environment

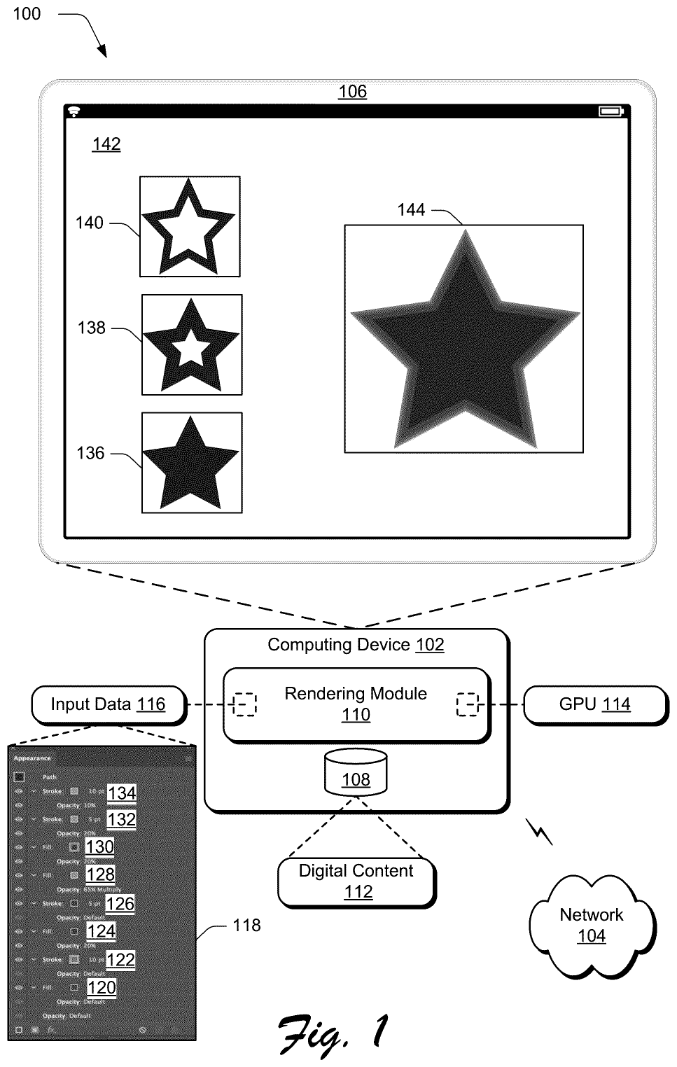

FIG. 1 is an illustration of an environment 100 in an example implementation that is operable to employ digital systems and techniques as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

The illustrated environment 100 also includes a display device 106 that is communicatively coupled to the computing device 102 via a wired or a wireless connection. A variety of device configurations are usable to implement the computing device 102 and/or the display device 106. For example, the display device 106 is an ultra-high-definition display device having a display resolution of 4K, 5K, 8K, etc. The computing device 102 includes a storage device 108 and a rendering module 110. The storage device 108 is illustrated to include digital content 112 such as digital images, digital artwork, digital videos, etc.

The computing device 102 and/or the rendering module 110 have access to a graphics processing unit (GPU) 114 which is representative of multiple GPUs 114 in some examples. In one example, the computing device 102 includes the GPU 114 in addition to a central processing unit (CPU). In another example, the GPU is available to the computing device 102 and the rendering module 110 via the network 104. For example, the computing device 102 and the rendering module 110 leverage the GPU 114 (e.g., GPU 114 computing kernels) for processing and rendering digital content 112 and/or for processing data in series or parallel with the CPU such as in a CPU-GPU 114 framework. In an example, this includes leveraging multiple CPUs and/or multiple GPUs 114.

The rendering module 110 is illustrated as having, receiving, and/or transmitting input data 116. The input data 116 describes a render tree 118 which includes indications of a set of vector objects 120-134 to be rendered as part of a rendering pipeline. As shown, each of the vector objects 120-134 has a corresponding shape or geometry and the rendering module 110 processes the input data 116 to identify unique geometries of the vector objects 120-134.

To do so in one example, the rendering module 110 identifies pairs or groups of the vector objects 120-134 which have matching geometries by matching vector shapes, strokes, fills, and so forth. For matching geometries of the vector objects 120-134 that are vector shapes, a first geometry matches a second geometry if the first and second geometries are affine transforms of each other. For instance, if the first geometry matches the second geometry, then the first geometry is a rotated, translated, and/or scaled version of the second geometry.

For matching geometries of the vector objects 120-134 that are strokes, the rendering module 110 compares stroke attributes of two stroke paths such as stroke width, types of caps and joins, dash patterns, etc. If the two stroke paths have matching stroke attributes, then the two stroke paths have matching geometries if outlines of the two stroke paths are affine transforms of each other (e.g., an outline of one of the stroke paths is a rotated, translated, and/or scaled version of an outline of the other stroke path). For matching geometries of the vector objects 120-134 that are fills, the rendering module 110 determines that all fills have matching geometries unless some vector effect (e.g., a visual feature) is applied over a particular fill. However, the vector objects 120-134 that are fills do not have matching geometries with the vector objects 120-134 that are strokes even if outlines of the fills and strokes are exactly the same.

By processing the input data 116 in this manner, the rendering module 110 determines that vector objects 120, 124, 128, and 130 have matching geometries; vector objects 122 and 134 have matching geometries; and vector objects 126 and 132 have matching geometries. Based on the three pairs or groups of the vector objects 120-134, the rendering module 110 identifies three unique geometries 136-140 in the render tree 118 which are displayed in a user interface 142 of the display device 106. Unique geometry 136 is a shape with fill, unique geometry 138 is a shape with a 10-point stroke, and unique geometry 140 is a shape with a 5-point stroke. For example, the rendering module 110 assigns a unique identifier to each of the unique geometries 136-140 and then tessellates the unique geometries 136-140.

In an example, the rendering module 110 tessellates the unique geometries 136-140 into sets of triangles. In this example, the rendering module 110 generates vertex data describing a tessellated unique geometry corresponding to the unique geometry 136 that includes metadata describing the unique identifier of the unique geometry 136; vertex data describing a tessellated unique geometry corresponding to the unique geometry 138 that includes metadata describing the unique identifier of the unique geometry 138; and vertex data describing a tessellated unique geometry corresponding to the unique geometry 140 that includes metadata describing the unique identifier of the unique geometry 140. The vertex data for each of the unique geometries 136-140 is aggregated into a single buffer and the aggregated data buffer is used as a vertex array buffer for all draw calls issued for the render tree 118.

The rendering module 110 computes an optimal render tree that includes optimal render objects which each require one draw call on the GPU 114. Accordingly, the rendering module 110 computes the optimal render tree to include a minimum number of the optimal render objects. However, some visual appearance attributes such as blend modes interact with a backdrop color to compute a final output color on a render target. In some examples, the GPU 114 does not support read-after-write memory consistency during a fragment shader stage of the rendering pipeline. In these examples, the rendering module 110 adds a new optimal render object to the optimal render tree whenever a vector object is identified in the render tree 118 having such a visual appearance attribute (e.g., a blend mode). For example, the rendering module 110 adds a new optimal render object to the optimal render tree because vector object 126 and vector object 128 are multiplied in a blend operation.

Each optimal render object included in the optimal render tree includes additional metadata describing all of the vector objects 120-134 which map to the optimal render object. By leveraging this metadata, the rendering module 110 is capable of rendering more than one of the vector objects 120-134 in a single draw call using instanced rendering. To do so, the rendering module 110 computes a number of instances needed for the optimal render objects such that all of the vector objects 120-134 which map to each of the optimal render objects are rendered. For instance, the vector objects 120-134 need to be ordered based on their z-order in the render tree (120, 122, 124, 126, 128, 130, 132, 134) and the aggregated vertex array buffer is ordered by occurrences of the unique geometries 136-140 in the render tree 118 (136, 138, 140).

In order to ensure that a rendering order is in the z-order of the vector objects 120-134 and because the render tree 118 includes a blend operation, the rendering module 110 computes the optimal render tree as including a first optimal render object and a second optimal render object. For example, the first optimal render object includes a first instance having the unique geometry 136 for the vector object 120 and the unique geometry 138 for the vector object 122. The first optimal render object also includes a second instance having the unique geometry 136 for the vector object 124 and the unique geometry 140 for the vector object 126.

Continuing the previous example, the second optimal render object includes a first instance having the unique geometry 136 for the vector object 128. The second optimal render object includes a second instance having the unique geometry 136 for the vector object 130 and the unique geometry 140 for the vector object 132. Finally, the second optimal render object includes a third instance having the unique geometry 138 for the vector object 134.

The rendering module 110 computes a primitive mask array for each of the two instances of the first optimal render object and a primitive mask array for each of the three instances of the second optimal render object. The primitive mask arrays are defined such that if an ith bit of a primitive mask array is set to 1, then the corresponding instance needs to render a geometry corresponding to unique geometry i. Thus, each of the primitive mask arrays includes a number of bits equal to a number of the unique geometries 136-140. Accordingly, the rendering module 110 computes primitive mask arrays of {1, 1, 0} and {1, 0, 1} for the first and second instances of the first optimal render object, respectively. The rendering module 110 computes primitive mask arrays of {1, 0, 0}, {1, 0, 1}, and {0, 1, 0} for the first, second, and third instances of the second optimal render object, respectively.

The rendering module 110 executes a vertex shader for all vertices in the aggregated vertex array buffer and uses the primitive mask arrays for each of the instances to determine which vertices to pass to a next stage of the rendering pipeline. For example, the vertex shader filters out all vertices that do not correspond to a value of 1 in the primitive mask arrays. The rendering module 110 passes the remaining vertices to a fragment shader which computes final colors for each rasterized fragment based on appearance attributes for corresponding instances and outputs to a render target. The rendering module 110 combines the rendered targets as a rendered vector object 144 which is displayed in the user interface 142. By leveraging the unique geometries 136-140 in this manner, the rendering module 110 generates the rendered vector object 144 by only tessellating the three unique geometries 136-140 rather than tessellating the eight geometries of the vector objects 120-134 as in conventional rendering techniques.

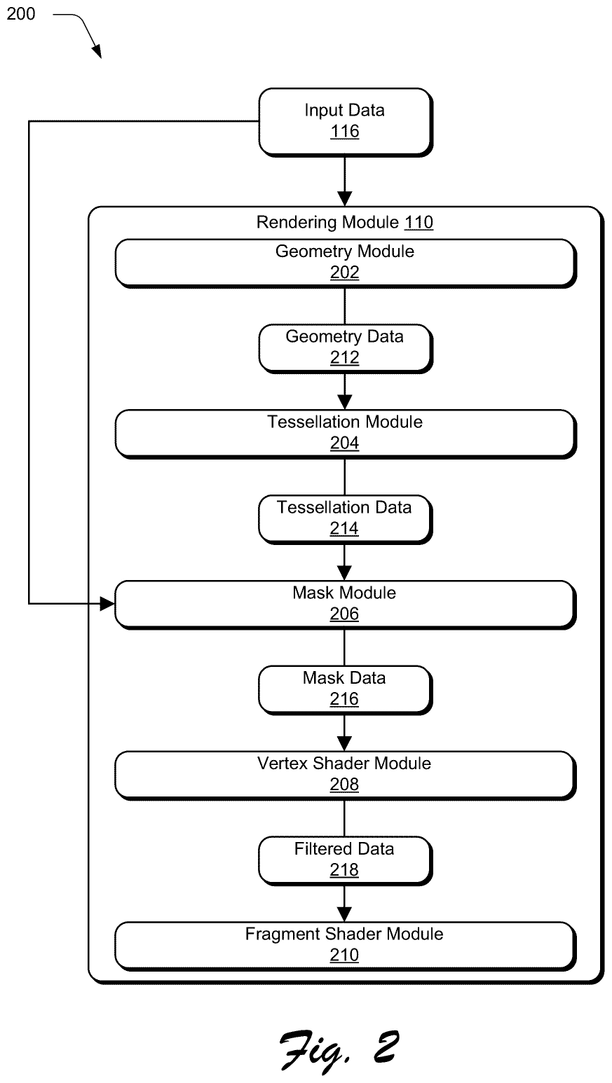

FIG. 2 depicts a system 200 in an example implementation showing operation of a rendering module 110. The rendering module 110 is illustrated to include a geometry module 202, a tessellation module 204, a mask module 206, a vertex shader module 208, and a fragment shader module 210. As shown, the rendering module 110 receives the input data 116 describing an input render tree 118. For example, the geometry module 202 receives and processes the input data 116 to generate geometry data 212.

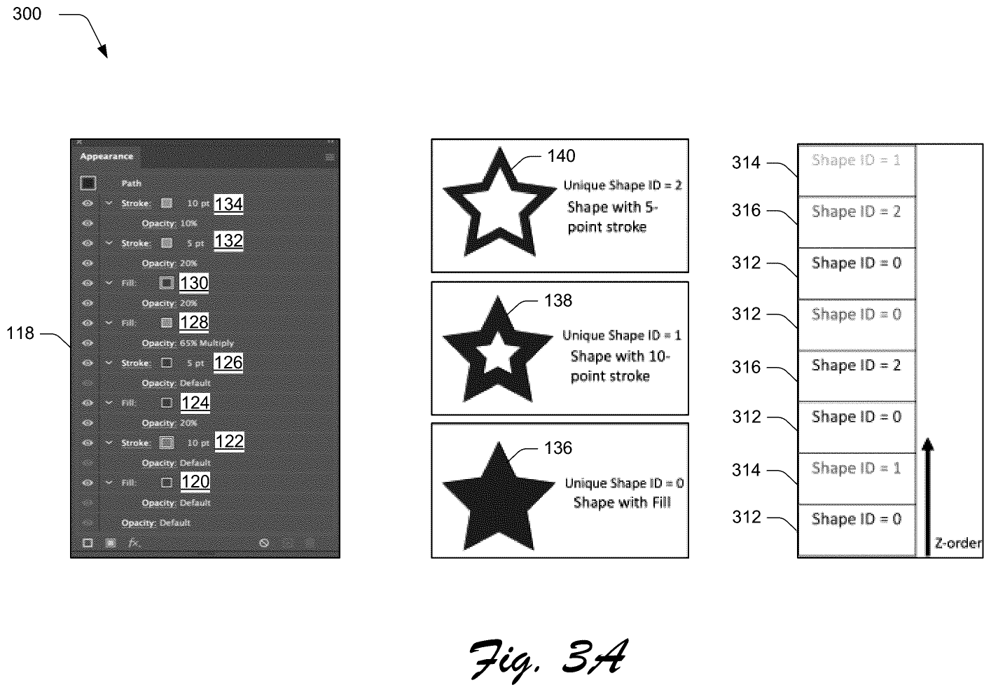

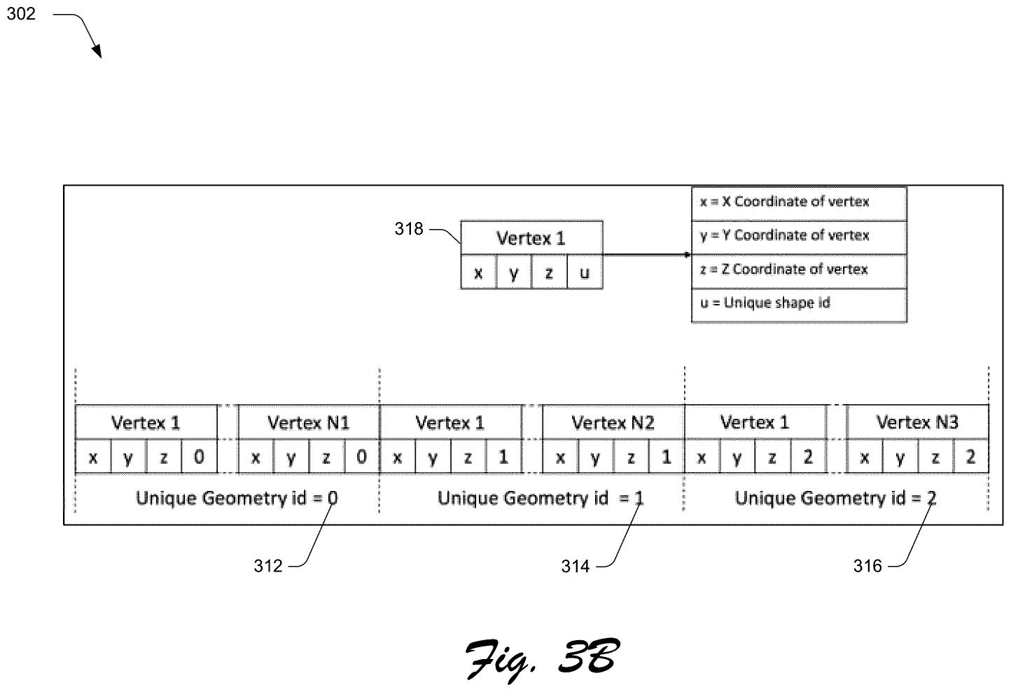

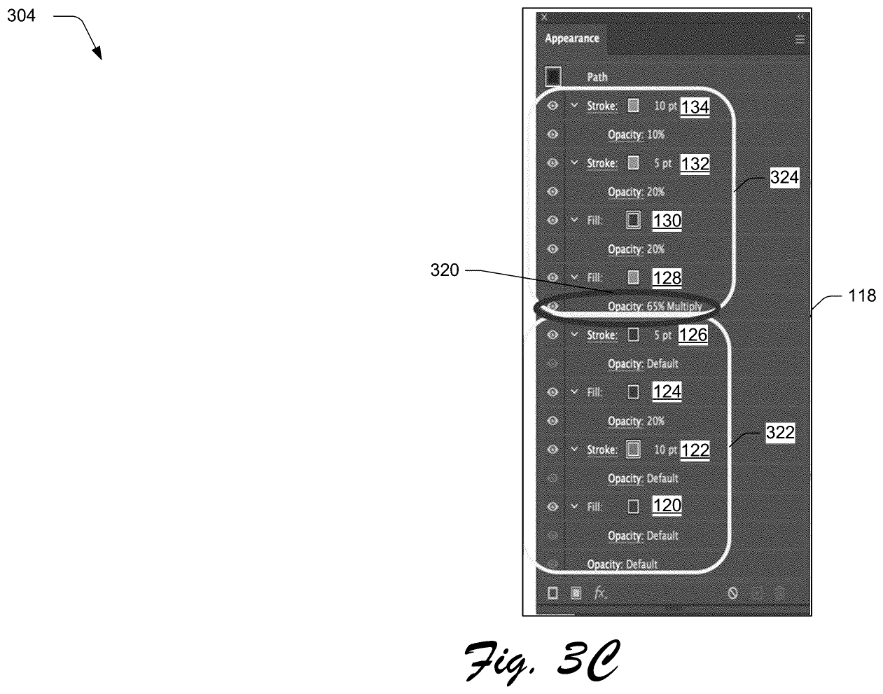

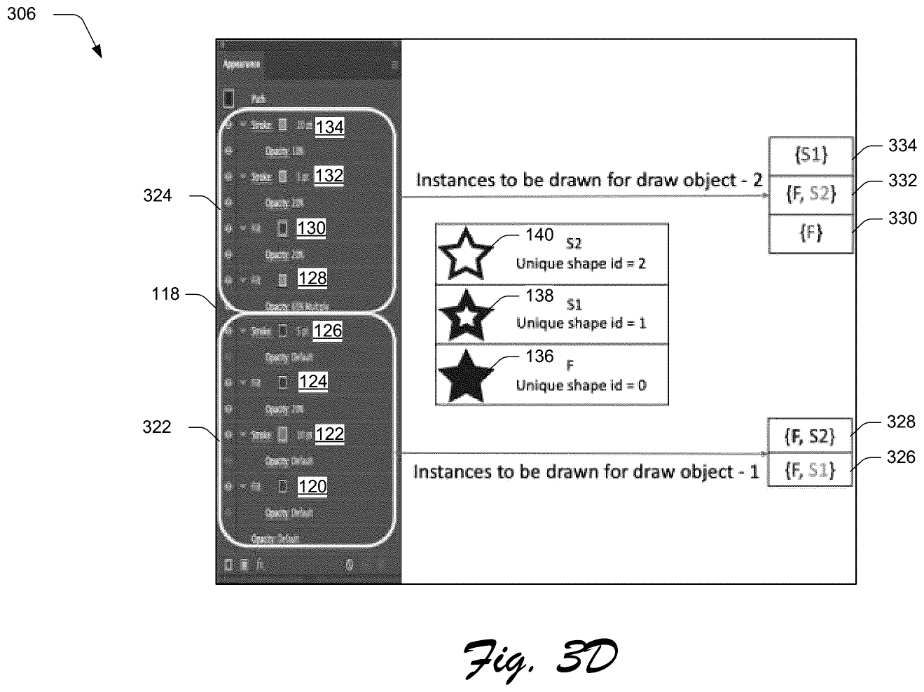

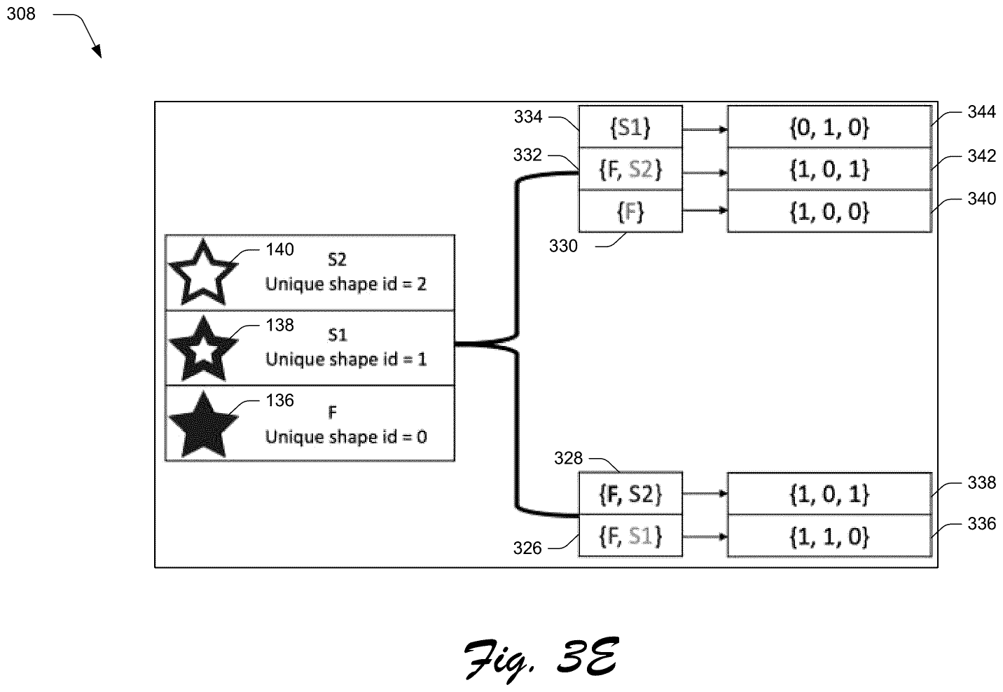

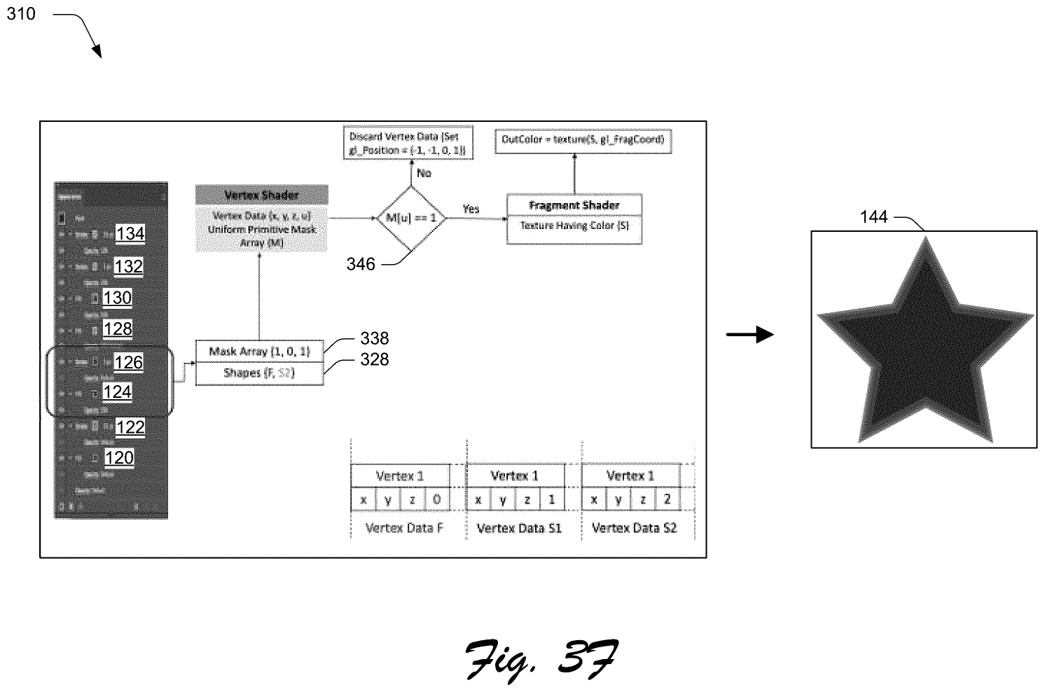

FIGS. 3A, 3B, 3C, 3D, 3E, and 3F illustrate an example of efficiently rendering a vector object. FIG. 3A illustrates a representation 300 of identifying unique geometries from a set of geometries of vector objects included in a render tree. FIG. 3B illustrates a representation 302 aggregated vertex data generated by tessellating the unique geometries. FIG. 3C illustrates a representation 304 of computing an optimal render tree that includes optimal render objects. FIG. 3D illustrates a representation 306 of determining instances for each of the optimal render objects included in the optimal render tree. FIG. 3E illustrates a representation 308 of computing a primitive mask array for each of the determined instances. FIG. 3F illustrates a representation 310 of a vector object rendered using systems for efficiently rendering vector objects.

With reference to FIG. 2 and FIG. 3A, the geometry module 202 receives the input data 116 which describes the input render tree 118 that includes vector objects 120-134. The input render tree 118 is included in a rendering pipeline and the vector objects 120-134 are to be rendered in the rendering pipeline. For instance, each of the vector objects 120-134 has a corresponding shape or geometry and the geometry module 202 processes the input data 116 to identify unique geometries of the vector objects 120-130 by determining which of the vector objects 120-130 have matching shapes or geometries. For example, vector object 120 has a shape with a fill, vector object 122 has a shape with a 10-point stroke, vector object 124 has a shape with a fill, vector object 126 has a shape with a 5-point stroke, vector object 128 has a shape with a fill, vector object 130 has a shape with a fill, vector object 130 has a shape with a 5-point stroke, and vector object 134 has a shape with a 10-point stroke.

The geometry module 202 defines N as a number of the vector objects 120-134 included in the input render tree 118 and maintains a set of unique objects U having k unique objects such that each object in U has a unique integer identifier in [0, k). By definition, the geometry module 202 determines that all fill objects have matching geometries unless a particular fill object has an additional applied vector effect (e.g., an additional visual feature). Based on this definition, the geometry module 202 determines that vector objects 120, 124, 128, and 130 have matching geometries.

The geometry module 202 determines that the vector objects 120-134 have matching geometries if vector shapes of the vector objects 120-134 are affine transforms of each other. For example, if a first vector object of the vector objects 120-134 has a geometry that matches a geometry of a second vector object of the vector objects 120-134, then a vector shape of the first vector object is a rotated, scaled, and/or translated version of a vector shape of the second vector object. In one example, this is representable as:
for each (i) in (N) do
if U contains i then
u=U[i]
S[i]=S[u]
else
S←S+(i,k)
U←U+i
k←k+1
   where: N represents the number of the vector objects 120-134 included in the input render tree 118; U represents a set of unique objects, geometries, or shapes of the vector objects 120-134; k is a size of U; and S is a map of a shape versus a shape identifier.

In order to identify whether stroke objects have a matching geometry, the geometry module 202 first compares stroke attributes of two stroke paths. The stroke attributes include stoke width, types of caps and joins, dash patterns, and so forth. If the two stroke paths have matching stoke attributes, then the two stroke paths have matching geometries if outlines of the two stroke paths are affine transforms of each other. For example, an outline of one of the stroke paths is a rotated, scaled, and/or translated version of an outline of the other one of the stroke paths. However, a stroke object and a fill object do not have matching geometries even if an outline of the stroke object is exactly the same as an outline of the fill object.

The geometry module 202 determines that the vector object 122 and the vector object 134 have matching geometries and that the vector object 126 and the vector object 132 have matching geometries. Based on the three pairs or groups of the vector objects 120-134 that have matching geometries, the geometry module 202 identifies three unique geometries 136-140. For example, the vector objects 120, 124, 128, and 130 have unique geometry 136; the vector objects 122 and 134 have unique geometry 138; and the vector objects 126 and 132 have unique geometry 140. Although examples are described in which the unique geometries 136-140 are identified by matching geometries of the vector objects 120-134, it is to be appreciated that in some examples, the unique geometries 136-140 are identified using additional techniques or alternative techniques. The geometry module 202 assigns unique identifier 312 to the unique geometry 136; unique identifier 314 to the unique geometry 138; and unique identifier 316 to the unique geometry 140. The unique identifiers 312-316 are organized according to a z-order of the vector objects 120-134 in the input render tree 118. For instance, the z-order of the vector objects 120-134 is 120, 122, 124, 126, 128, 130, 132, and 134 and the z-order of the unique identifiers 312-316 is 312, 314, 312, 316, 312, 312, 316, and 314.

For example, the geometry module 202 generates the geometry data 212 as describing the vector objects 120-134 that have the unique geometries 136-140 and the unique identifiers 312-316 of the unique geometries 136-140. The tessellation module 204 receives and processes the geometry data 212 to generate tessellation data 214. In one example, the tessellation module 204 processes the geometry data 212 to tessellate each of the unique geometries 136-140 into a set of triangles. For instance, the tessellation module 204 tessellates a Bezier bounded geometry of the unique geometry 136 into a first set of triangles; tessellates a Bezier bounded geometry of the unique geometry 138 into a second set of triangles; and tessellates a Bezier bounded geometry of the unique geometry 140 into a third set of triangles.

The tessellation module 204 generates vertex data describing the first set of triangles and adds metadata describing the unique identifier 312 to the vertex data. The tessellation module 204 also generates vertex data describing the second set of triangles and adds metadata describing the unique identifier 314 to the vertex data. Similarly, the tessellation module 204 generates vertex data describing the third set of triangles and adds metadata describing the unique identifier 316 to the vertex data.

The tessellation module 204 leverages the vertex data describing the first, second, and third sets of triangles and the corresponding metadata describing the unique identifiers 312, 314, and 316 to generate a data structure 318 for each vertex of each triangle included int the first, second, and third sets of triangles. As shown in FIG. 3B, each data structure 318 includes an x-coordinate, a y-coordinate, and a z-coordinate of its corresponding vertex as well as one of the unique identifiers 312, 314, and 316 which indicates the unique geometry 136, 138, 140 that includes the corresponding vertex. The tessellation module 204 aggregates each data structure 318 into a single buffer. This aggregated data buffer is used as a vertex array buffer for draw calls issued to the input render tree 118. The tessellation module 204 generates the tessellation data 214 as describing the vertex array buffer.

The mask module 206 receives the tessellation data 214 and the input data 116 and processes the tessellation data 214 and/or the input data 116 to generate mask data 216. To do so, the mask module 206 processes the input render tree 118 and begins to compute an optimal render tree that includes optimal render objects based on the unique identifiers 312-316 and appearance attributes of the vector objects 120-134. Each of the optimal render objects included in the optimal render tree requires one draw call on the GPU 114. Accordingly, the mask module 206 generates the optimal render tree to have a minimum number of the optimal render objects to maximize efficiency of utilizing the GPU 114 which represents multiple GPU cores in this example.

For example, the rendering module 110 is capable of rendering multiple ones of the vector objects 120-134 in a single draw call using the vertex array buffer and a primitive masking technique. However, the GPU 114 does not support read-after-write memory consistency during a fragment shader stage of the rendering pipeline in scenarios in which read and write operations to a render target are performed in a same draw call. In these scenarios, read operations are only performable correctly if write operations were performed during a previous draw call using barriers and other available synchronization primitives. Since some appearance attributes such as blend modes introduce a dependency on read-after-write memory for correct composition of colors during the fragment shader stage of the rendering pipeline, the mask module 206 adds a new optimal render object to the optimal render tree each time such an object (e.g., a blend mode) is encountered in the input render tree 118.

As shown in FIG. 3C, the input render tree 118 includes a blend mode 320. Because of this, the mask module 206 generates the optimal render tree as having a first optimal render object 322 and a second optimal render object 324. For example, a write operation is performed in a draw call associated with the first optimal render object 322 which precedes a draw call associated with the second optimal render object 324 such that a read operation is performable correctly for the blend mode 320 in the draw call associated with the second optimal render object 324. The mask module 206 includes metadata in the first optimal render object 322 describing the vector objects 120, 122, 124, 126 and the mask module 206 includes metadata in the second optimal render object 324 describing the vector objects 128, 130, 132, 134.

The mask module 206 determines a minimum number of instances for the first optimal render object 322 in order to render the vector objects 120, 122, 124, 126 and also determines a minimum number of instances for the second optimal render object 324 in order to render the vector objects 128, 130, 132, 134. Since the vector objects 120-134 need to be ordered by their z-order in the input render tree 118 and because the vertex data in the vertex array buffer is ordered by occurrences of the unique objects 136-140 in the input render tree 118, the mask module 206 computes the minimum number of instances for the first optimal render object 322 and the minimum number of instance for the second optimal render object 324 and also ensures that rendering order is in a same order as the z-order. In on example, this is representable as:
while (art in T) do
countƒarray holding instance count
current=0
lastShapeId=−1
while ShapeId(art)>lastShapeId do
id=ShapeId (art)
count←count+1
current←current+1
lastShapeId=id
if art has next then
art←art.next
count←Insert current
current=0
   where: T represents the input render tree 118; and N represents a number of the unique geometries 136-140.

The mask module 206 determines the number of instances for the first optimal render object 322 is two and then generates a first instance 326 and a second instance 328 for the first optimal render object 322. Similarly, the mask module 206 determines the number of instances for the second optimal render object 324 is three and then generates a first instance 330, a second instance 332, and a third instance 334 for the second optimal render object 324. In order to render the vector objects 120-126, the first instance 326 includes the unique geometry 136 for the vector object 120 and the unique geometry 138 for the vector object 122. Following the z-order of the input render tree 118, the second instance 328 includes the unique geometry 136 for the vector object 124 and the unique geometry 140 for the vector object 126.

In order to render the vector objects 128-134, the first instance 330 includes the unique geometry 136 for the vector object 128. Also following the z-order of the input render tree 118, the second instance 332 includes the unique geometry 136 for the vector object 130 and the unique geometry 140 for the vector object 132. Finally, the third instance 334 includes the unique geometry 138 for the vector object.

After generating the first instance 326 and the second instance 328 for the first optimal render object 322, the mask module 206 computes a primitive mask array for the first and second instances 326, 328. Similarly, after generating the first instance 330, the second instance 332, and the third instance 334 for the second optimal render object 324, the mask module 206 computes a primitive mask array for the first, second, and third instances 330, 332, 334. The primitive mask arrays are defined such that if the ith bit of a primitive mask array is set to 1, then an instance corresponding to the primitive mask array needs to render a geometry corresponding to unique geometry i. In one example, computing the primitive mask arrays is representable as:
while (art in T) do
MaskArray←MaskArray of size N, each entry=0
lastShapeId=−1
while ShapeId(art)>lastShapeId do
id=ShapeId (art)
MaskArray[id]=1
lastShapeId=id
if art has next then
art←art.next
   where: T represents the input render tree 118; and N represents the number of the unique geometries 136-140.

As illustrated in FIG. 3E, the mask module 206 computes a primitive mask array 336 for the first instance 326 and a primitive mask array 338 for the second instance 328. The mask module 206 also computes a primitive mask array 340 for the first instance 330, a primitive mask array 342 for the second instance 332, and a primitive mask array 344 for the third instance 334. Based on the definition above, the primitive mask array 336 is {1, 1, 0} and the primitive mask array 338 is {1, 0, 1}. Similarly, the primitive mask array 340 is {1, 0, 0}, the primitive mask array 342 is {1, 0, 1}, and the primitive mask array 344 is {0, 1, 0}. The mask module 206 generates the mask data 216 as describing the primitive mask arrays 336-344.

The vertex shader module 208 receives and processes the mask data 216 to generate filtered data 218. For example, the vertex shader module 208 includes a vertex shader. The vertex shader module 208 executes the vertex shader for all vertices included in the vertex array buffer and the primitive mask arrays 336-344 described by the mask data 216 are used to determine which vertices are sent to a next stage in the rendering pipeline. For example, mask data 216 is capable of being passed to the vertex shader using uniform buffers or vertex array objects.

As illustrated in FIG. 3F, the vertex shader module 208 defines M as a primitive mask array input to the vertex shader. For any vertex shader invocation v, let u be the unique identifier and iid be the instance identifier, if M [iid] [u]≠1, then discard the vertex. At decision 346, the vertex shader discards these vertices and then generates the filtered data 218 as describing the remaining vertices. The fragment shader module 210 receives and processes the filtered data 218 using a fragment shader. For example, the fragment shader module 210 computes a final color for each rasterized fragment based on appearance attributes for corresponding instances and outputs to render targets. The rendering module 110 combines the rendered targets as a rendered vector object 144. By leveraging the unique geometries 136-140 in this manner, the rendering module 110 generates the rendered vector object 144 by only tessellating the three unique geometries 136-140 rather than tessellating the eight geometries of the vector objects 120-134 as in conventional rendering techniques. In this way, the described systems for efficiently rendering vector objects decrease rendering time and memory usage relative to the conventional rendering techniques.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

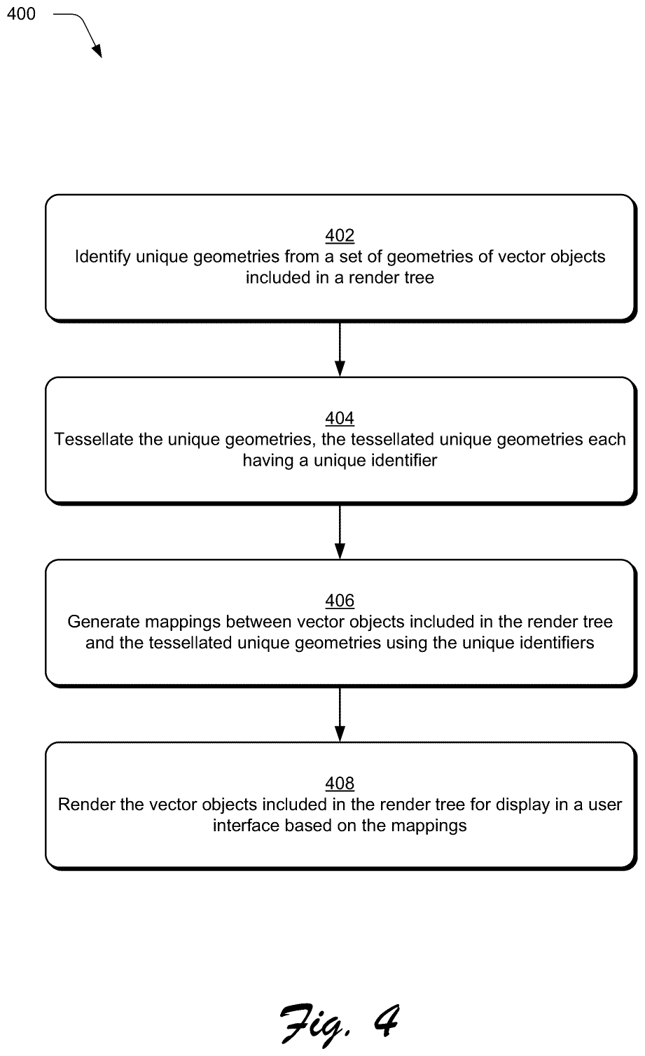

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-3. FIG. 4 is a flow diagram depicting a procedure 400 in an example implementation in which unique geometries are identified from a set of geometries of vector objects included in a render tree and the vector objects are rendered for display in a user interface based on the unique geometries.

Unique geometries are identified from a set of geometries of vector objects included in a render tree (block 402). In an example, the computing device 102 implements the rendering module 110 to identify the unique geometries. The unique geometries are tessellated, the tessellated unique geometries each having a unique identifier (block 404). For example, the rendering module 110 tessellates the unique geometries as the tessellated unique geometries.

Mappings are generated between vector objects included in the render tree and the tessellated unique geometries using the unique identifiers (block 406). The computing device 102 implements the rendering module 110 to generate the mappings in some examples. The vector objects included in the render tree are rendered for display in a user interface based on the mappings (block 408). In an example, the rendering module 110 renders the vector objects included in the render tree for display in the user interface.

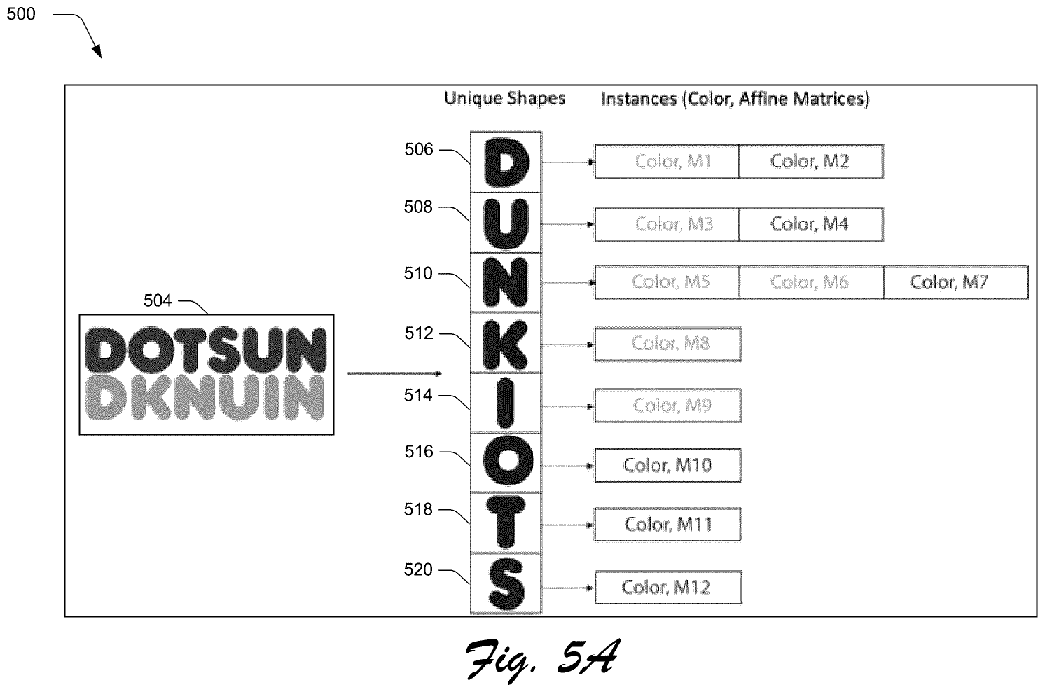

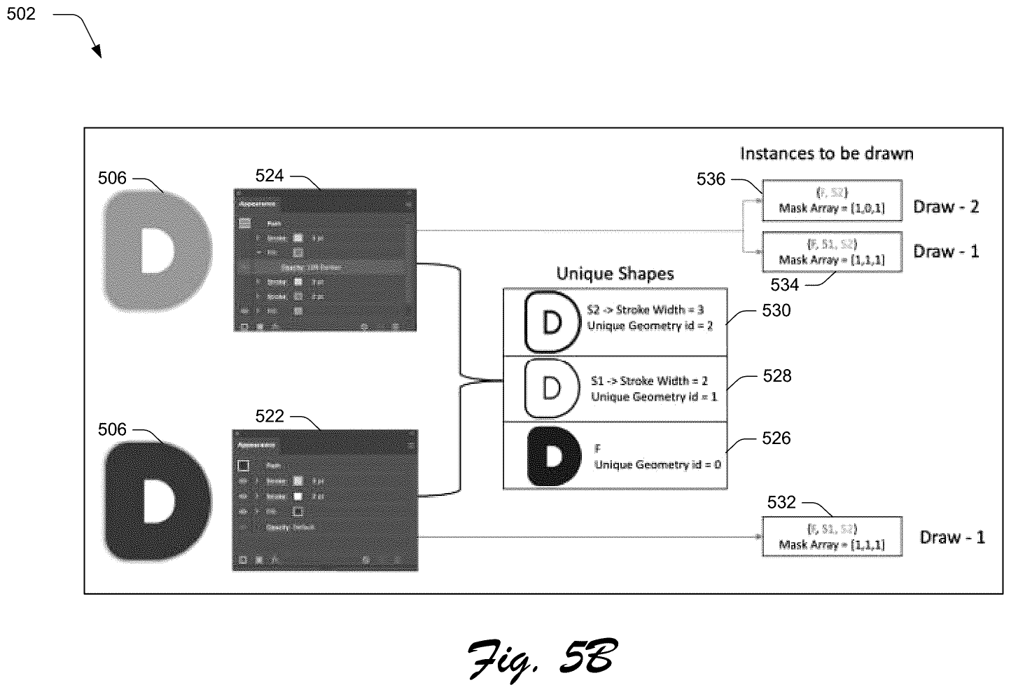

FIGS. 5A and 5B illustrate an example of efficiently rendering vector-based glyphs. FIG. 5A illustrates a representation 500 of identifying unique geometries from a set of geometries of vector objects. FIG. 5B illustrates a representation 502 of computing primitive mask arrays for rendering the vector objects. As shown in FIG. 5A, the input data 116 describes vector-based glyphs 504 to be rendered as part of a rendering pipeline. The vector-based glyphs 504 are “DOTSUN” above “DKNUIN.” The rendering module 110 identifies unique geometries 506-520 from the set of geometries included in the vector-based glyphs 504. As shown, unique geometry 506 is “D;” unique geometry 508 is “U;” unique geometry 510 is “N;” unique geometry 512 is “K;” unique geometry 514 is “I;” unique geometry 516 is “O;” unique geometry 518 is “T;” and unique geometry 520 is “S.” The rendering module 110 computes instances and transformations for each of the unique geometries 506-520. This is illustrated in greater detail in FIG. 5B for unique geometry 508 which has two instances that each include multiple fills and strokes.

As shown, a first render tree 522 and a second render tree 524 include unique geometries 526-530. Unique geometry 526 is a fill, unique geometry 528 is a stroke width of 2, and unique geometry 530 is a stroke width of 3. The rendering module 110 computes primitive mask array 532 for the render tree 522. However, the render tree 524 includes a blend mode. Because of this, the rendering module 110 computes primitive mask array 534 and primitive mask array 536 for the render tree 524. Accordingly, the rendering module 110 is capable of rendering the unique geometry 506 by tessellating only three unique geometries 523-530 instead of tessellating eight geometries as in conventional systems.

### Example System and Device

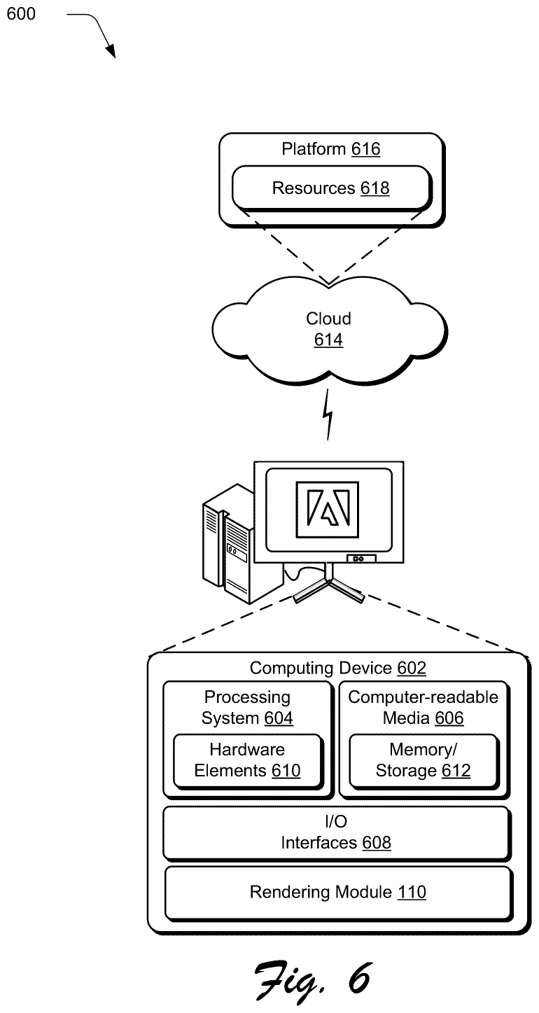

FIG. 6 illustrates an example system 600 that includes an example computing device that is representative of one or more computing systems and/or devices that are usable to implement the various techniques described herein. This is illustrated through inclusion of the rendering module 110. The computing device 602 includes, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that are configured as processors, functional blocks, and so forth. This includes example implementations in hardware as an application specific integrated circuit or other logic device formed using one or more semiconductors. The hardware elements 610 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 606 is illustrated as including memory/storage 612. The memory/storage 612 represents memory/storage capacity associated with one or more computer-readable media. In one example, the memory/storage 612 includes volatile media (such as random access memory (RAM)) and/or nonvolatile media (such as read only memory (ROM), Flash memory, optical disks, magnetic disks, and so forth). In another example, the memory/storage 612 includes fixed media (e.g., RAM, ROM, a fixed hard drive, and so on) as well as removable media (e.g., Flash memory, a removable hard drive, an optical disc, and so forth). The computer-readable media 606 is configurable in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 602. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 602, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 610. For example, the computing device 602 is configured to implement particular instructions and/or functions corresponding to the software and/or hardware modules. Accordingly, implementation of a module that is executable by the computing device 602 as software is achieved at least partially in hardware, e.g., through use of computer-readable storage media and/or hardware elements 610 of the processing system 604. The instructions and/or functions are executable/operable by one or more articles of manufacture (for example, one or more computing devices 602 and/or processing systems 604) to implement techniques, modules, and examples described herein.

The techniques described herein are supportable by various configurations of the computing device 602 and are not limited to the specific examples of the techniques described herein. This functionality is also implementable entirely or partially through use of a distributed system, such as over a “cloud” 614 as described below.

The cloud 614 includes and/or is representative of a platform 616 for resources 618. The platform 616 abstracts underlying functionality of hardware (e.g., servers) and software resources of the cloud 614. For example, the resources 618 include applications and/or data that are utilized while computer processing is executed on servers that are remote from the computing device 602. In some examples, the resources 618 also include services provided over the Internet and/or through a subscriber network, such as a cellular or Wi-Fi network.

The platform 616 abstracts the resources 618 and functions to connect the computing device 602 with other computing devices. In some examples, the platform 616 also serves to abstract scaling of resources to provide a corresponding level of scale to encountered demand for the resources that are implemented via the platform. Accordingly, in an interconnected device embodiment, implementation of functionality described herein is distributable throughout the system 600. For example, the functionality is implementable in part on the computing device 602 as well as via the platform 616 that abstracts the functionality of the cloud 614.

### CONCLUSION

Although implementations of systems for efficiently rendering vector objects have been described in language specific to structural features and/or methods, it is to be understood that the appended claims are not necessarily limited to the specific features or methods described. Rather, the specific features and methods are disclosed as example implementations of systems for efficiently rendering vector objects, and other equivalent features and methods are intended to be within the scope of the appended claims. Further, various different examples are described and it is to be appreciated that each described example is implementable independently or in connection with one or more other described examples.

1. In a digital medium environment, a method implemented by a computing device, the method comprising:
identifying, by the computing device, unique geometries from a set of geometries of vector objects included in a render tree of a path, where the vector objects comprise strokes and/or fills of the path;
tessellating, by the computing device, the unique geometries, the tessellated unique geometries each having a unique identifier;
generating, by the computing device, mappings between the vector objects included in the render tree of the path and the tessellated unique geometries using the unique identifiers; and
rendering, by the computing device, the vector objects included in the render tree of the path for display in a user interface based on the mappings in a single draw call while maintaining a z-order of the rendered vector objects corresponding to a z-order of the vector objects included in the render tree of the path.

2. The method as described in claim 1, wherein generating the mappings includes computing an optimal render tree having a render object with an instance that corresponds to a first vector object and a second vector object of the vector objects included in the render tree of the path.

3. The method as described in claim 2, wherein the first vector object and the second vector object are rendered using a primitive mask for the instance.

4. The method as described in claim 3, wherein the primitive mask has a number of bits equal to a number of the unique geometries.

5. The method as described in claim 3, wherein values of bits of the primitive mask are determined based on the z-order of the vector objects included in the render tree of the path.

6. The method as described in claim 1, wherein the unique identifiers are included in metadata of vertex data describing vertices of triangles of the tessellated unique geometries.

7. The method as described in claim 1, wherein the vector objects included in the render tree of the path are rendered using instanced rendering.

8. The method as described in claim 1, wherein a first vector object and a second vector object of the vector objects included in the render tree of the path have a same unique geometry of the unique geometries and a geometry of the first vector object in the render tree of the path is rotated, scaled, or translated relative to a geometry of the second vector object in the render tree of the path.

9. The method as described in claim 1, wherein a first vector object and a second vector object of the vector objects included in the render tree of the path have a same geometry in the render tree of the path and the first vector object has a first unique geometry of the unique geometries and the second vector object has a second unique geometry of the unique geometries.

10. The method as described in claim 9, wherein the first vector object is a stroke object and the second vector object is a fill object.

11. The method as described in claim 1, further comprising:
detecting that a first vector object and a second vector object are blended in the render tree of the path; and
adding a render object to an optimal render tree based on the detecting.

12. A system comprising:
a geometry module implemented by one or more processing devices to identify unique geometries from a set of geometries of vector objects included in a render tree of a path, where the vector objects comprise strokes and/or fills of the path;
a tessellation module implemented by the one or more processing devices to tesselate the unique geometries, the tessellated unique geometries each having a unique identifier;
a primitive mask module implemented by the one or more processing devices to:
compute an optimal render tree having render objects with instances determined using the unique identifiers and a z-order of the vector objects included in the render tree of the path; and
generate a primitive mask array for each of the instances of each of the render objects included in the optimal render tree; and
a shader module implemented by the one or more processing devices to render the vector objects included in the render tree of the path for display in a user interface based on the primitive mask arrays.

13. The system as described in claim 12, wherein a first vector object and a second vector object of the vector objects included in the render tree of the path are rendered using instanced rendering.

14. The system as described in claim 12, wherein the unique identifiers are included in metadata of vertex data describing vertices of triangles of the tessellated unique geometries.

15. The system as described in claim 12, wherein each of the primitive mask arrays includes a number of bits equal to a number of the unique geometries.

16. The system as described in claim 12, wherein a first vector object and a second vector object of the vector objects included in the render tree of the path have a same unique geometry of the unique geometries and a geometry of the first vector object in the render tree of the path is rotated, scaled, or translated relative to a geometry of the second vector object in the render tree of the path.

17. A non-transitory computer-readable storage medium storing executable instructions, which when executed by a processing device, cause the processing device to perform operations comprising:
identifying unique geometries from a set of geometries of vector objects included in a render tree;
tessellating the unique geometries, the tessellated unique geometries each having a unique identifier;
generating mappings between the vector objects included in the render tree and the tessellated unique geometries using the unique identifiers and a z-order of the vector objects included in the render tree; and
rendering the vector objects included in the render tree for display in a user interface based on the mappings in a single draw call while maintaining a z-order of the rendered vector objects corresponding to the z-order of the vector objects included in the render tree.

18. The non-transitory computer-readable storage medium as described in claim 17, wherein generating the mappings includes computing an optimal render tree having a render object with an instance that corresponds to a first vector object and a second vector object of the vector objects included in the render tree.

19. The non-transitory computer-readable storage medium as described in claim 18, wherein the first vector object and the second vector object are rendered using a primitive mask for the instance.

20. The non-transitory computer-readable storage medium as described in claim 17, wherein a first vector object and a second vector object of the vector objects included in the render tree have a same unique geometry of the unique geometries and a geometry of the first vector object in the render tree is rotated, scaled, or translated relative to a geometry of the second vector object in the render tree.
